(19) United States
(12) Patent Application Publication
(10) Pub. No.: US 2009/0033128 A1
(43) Pub. Date: Feb. 5, 2009

(54) Vehicle Roof with a Roof Module

(75) Inventor: Dominik Hoelzel, Groebenzell (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WEBASTO AG, Stockdorf (DE)

(21) Appl. No.: 12/180,693

(22) Filed: Jul. 28, 2008

(30) Foreign Application Priority Data
Jul. 31, 2007 (DE) 10 2007 036 366

(51) Int. Cl. B60J 7/00; B62D 25/07

(52) U.S. Cl. 296/216.01

(57) ABSTRACT

A vehicle roof with a roof frame surrounding a roof opening and a roof module covering the roof opening, which roof module has guide rails and a covering element movably mounted on the guide rails, the roof module having at least two guide rails and a connecting element connecting the guide rails, and at least the guide rails being fastened to the underside of a flange of the roof frame.

### BACKGROUND OF THE INVENTION

1. Field of the Invention

The invention relates to a vehicle roof with a roof frame surrounding a roof opening and a roof module covering the roof opening, which roof module has guide rails and a covering element mounted movably on the guide rails.

2. Related Technology

Known from DE 102 18 601 A1 is a vehicle roof which has a roof frame with side members and cross members which is mounted permanently on the vehicle and surrounds a roof opening. A roof module which closes the roof opening is fastened by means of a carrier frame to a roof flange formed on the roof frame and projecting inwardly, an outer flange portion of the carrier frame being bonded to the upper side of the roof flange by means of an adhesive bead. A respective lateral guide rail of an externally-guided sliding roof of the roof module is fastened to the inside of the carrier frame on each side, which carrier frame has a U-shaped cross-section. The carrier frame and the guide rail adjoining it on the inside significantly restrict the see-through area of a roof module having a transparent covering, such as a glass cover of the sliding roof.

Known from DE 10 2005 016 458 A1 is a roof design for a motor vehicle which has a roof frame surrounding a roof opening, to which roof frame various roof modules can be attached. The roof frame has a peripheral flange oriented towards the roof opening, on which is formed an inwardly-projecting flange extension as a support section, on the upper side of which an edge-mounted carrier frame of the roof module is fastened by bonding. The carrier frame may be additionally bonded to the upper side of the flange. On the one hand, the carrier frame forms an edge area which surrounds the roof module opening on the visible side, which roof module is closable by a movable cover; on the other hand, the carrier frame serves as a base for fastening a guide rail on which the cover is displaceably mounted. The guide rail is therefore spaced significantly from the flange or from the support section and is located under the cover substantially inside the roof module opening, thus restricting the see-through area if the cover is a glass cover.

In general, vehicle body shells or roof frames are known in which the body-shell welding flange is used for fastening (welding, bonding, etc.) the material of the roof skin, or for attaching a top-load externally-guided sliding roof. The front roof frame (windscreen cowl) and the rear roof frame are configured such that they can receive the roof material or roof skin or a top-load frame. According to the state of the art, a sheet of glass, polycarbonate (PC), steel, or plastic material is then mounted on this top-load frame.

With the conventional vehicle body shell design it is not possible to install a externally-guided sliding roof having an all-glass appearance from below. The upper side of the welding flange of the roof side members, and the front and rear roof frame or roof members, must form a level surface in order that the roof skin of a normal vehicle can be welded or bonded to this flange. For this reason all sheet-metal overlaps at the joints between the front and rear roof frames and the roof side members must be constructed downwardly. For the same reason, sheet-metal overlaps for welding together multi-skin roof frames and roof side members must be formed on the underside of the welding flange. No level surface for sealing a bottom-load externally-guided sliding roof from below therefore exists, because the conventional body shell is designed to meet the requirements of the top-load externally-guided sliding roof.

Given this body shell concept designed for top-load, modularization of the externally-guided sliding roof frame is not possible, because the front and rear frame parts must always be adapted to the new body shell contours and design surfaces of the roof skin, since the structure of the frame is always built up from the outer roof skin inwards, with a constant offset therefrom (e.g. glass panel 5 mm thickness, adhesive bead 5 mm thickness, sheet metal 1 mm thickness). Uncoupling of the design contour from the functional parts is therefore not possible.

For reasons of water management, the guide rails of a movable cover cannot be moved very close to the roof side member without creating additional complications. The abutment points between guide rail and front and rear frame parts must be sealed in a very complex and costly manner.

In the case of roof modules with externally-guided sliding elements and an all-glass appearance according to the state of the art, which are installed in the vehicle roof from above (top-load), the design of the water management in the frame of the roof module is a fundamental aspect. Usually, a one-piece frame (steel, plastic material, long fiber injection (LFI) material, etc.) is used, forming to the outside a closed surface without joints, so that water cannot reach the interior of the vehicle. In this case the frame serves as a mounting for all additional parts (glass, mechanism, light-shading, wind deflector, etc.), and partly as a stiffening element of the vehicle body shell.

The panels (of glass, PC, LFI, thermoplastic material, etc.) which close the gap between windscreen and rear window are also fastened to this frame, in front of and behind the at least one movable cover, so that an all-glass or unified appearance is obtained.

Bottom-load externally-guided sliding roofs are bonded into an opening of the roof skin from below. For this purpose, as a rule a reinforcing frame is welded into the roof skin. An all-glass “rail-to-rail” appearance (i.e. between the two lateral guide rails) and from the windscreen to the rear window is thereby made impossible, since a strip of roof skin is always visible between windscreen and sliding roof (or roof module) and rear window and sliding roof (or roof module), and between roof side members and sliding roof (or roof module).

A disadvantage of top-load systems is therefore that, because of its sealing function, the frame for this roof concept is very large, and corresponding tooling is consequently very expensive.

A further disadvantage of top-load systems is that the roof module installed from above is a new design for each vehicle model, since the body shell and roof skin will in most cases be different. The top-load frame is directly dependent on the design surfaces, since it is generated by a constant offset from the outer skin in each case. Modularization of the frame is therefore not possible.

With this system a continuous inner guide rail, in which a rear release mechanism moves the externally-guided sliding roof, is possible only under more difficult design conditions, because of the sealing of the cover and the water management between body shell and mechanism (guide rails), since the sliding roof mechanism would need to move through two levels of sealing to the interior of the vehicle if the interior is to be completely sealed to the outside. For this reason two guide rails, an inner and an outer guide rail, are usually required with top-load externally-guided sliding roofs. “Rail-to-rail” glazing is possible only if the inner and outer guide rails lie in a common Y-plane. This means a free transfer of external load to the outer guide rail via the sealing regions (cover seal and adhesive bead). If this free transfer is to be avoided the inner and outer guide rails must lie in two different Y-planes, requiring more installation space.

However, the two guide rails increase the cost of the mechanism, in comparison to a roof concept which requires only one guide rail.

A disadvantage of conventional bottom-load systems is that a reinforcing frame which must be designed into the body-shell roof is always necessary.

Furthermore, only a glass area which is shorter than the distance between the front roof frame and the rear roof frame can be incorporated. A strip of roof skin in front of the movable cover (above the windscreen cowl) and a strip of roof skin above the rear roof frame always remain, so that an all-glass appearance cannot be achieved. Moreover the corners of the cover must be rounded, since water management permits nothing else (XY-sealing and drainage of all water into the guide rails and the front part of the roof).

### GENERAL DESCRIPTION OF THE INVENTION

The invention provides a vehicle roof of the type mentioned in the introduction which avoids the above-mentioned disadvantages and is improved with regard to simplified installation of the roof module from below (bottom-load).

According to the invention, in a vehicle roof mentioned above, the roof module has at least two guide rails and a connecting element which connects the guide rails, and at least the guide rails are fastened to the underside of a flange of the roof frame.

In one embodiment, the invention provides a vehicle roof with a roof frame surrounding a roof opening and a roof module covering the roof opening, which roof module has guide rails and a covering element movably mounted on the guide rails, wherein the roof module has at least two guide rails and a connecting element connecting the guide rails, and wherein at least the guide rails are fastened to the underside of a flange of the roof frame.

The roof module therefore has a modular structure and can be easily adapted to different installation situations through selection and adaptation of the above-mentioned components. Because an intermediate support, as known from the prior art, is not used in the vehicle roof according to the invention, the guide rails disposed, in particular, in the longitudinal direction of the vehicle can be arranged away from the roof opening and outwardly towards the roof frame, so that, in the case of a roof module with transparent covering, the see-through area can have greater width, as compared to the known systems. In particular, with the vehicle roof according to the invention, an all-glass appearance can be provided if the roof module has a glass cover and glass panels, or such components made of transparent plastic material with a glass appearance, which fit continuously along the windscreen and the rear window and are fitted between the lateral frames of the vehicle roof.

In a preferred configuration, the flange has an inwardly-oriented flange extension which is formed in one layer. The flange extension therefore extends from the roof frame or the flange in the direction of the roof opening, the width of the flange extension (i.e. in the direction of the roof opening) being dependent on the requirements or the size of the respective vehicle roof, the roof module and the dimensions of the roof frame.

The flange extension is preferably one of two or more shell-like profile parts from which the spar-like roof frame is formed. This profile part constitutes the single-layer design. For adaptation to the particular roof situation, this profile part is configured during manufacture of the roof shell or roof frame according to the requirements and is combined with the roof frame to form a unit. The flange extension may also have a reinforcement which is formed, for example in zones, by a second layer or by beads or embossments.

The flange extension is preferably and advantageously formed all round the roof frame, so that it provides a continuous fixing surface for a roof module. However, the flange extension might also be provided only on particular parts of the roof frame, such as the two roof side members.

A seal is preferably attached to the upper side of the flange or the flange extension. Furthermore, a continuous seal may be fixed to the flange extension and, in particular, fitted to the edge of the flange extension. The seal seals the flange or the flange extension with respect to an upper covering and therefore forms an outer water channel on the flange, in which water can be drained towards the front and/or the rear.

In another embodiment, the invention provides a vehicle roof with a roof frame surrounding a roof opening, a roof module covering the roof opening and a flange, formed on the roof frame and oriented toward the roof opening, for fastening a roof module, preferably as described above, wherein a flange extension has, preferably on the front roof cross member and/or on the rear roof cross member, spaced from the flange, an enlarged support base for a panel (of the roof outer skin which is attachable thereto.

According to this embodiment, the flange extension is preferably formed on the front roof cross member and/or on the rear roof cross member as an enlarged support base for a panel of the outer roof skin which is fixable thereon. While a narrow flange extension for fixing the guide rail and for attaching a seal may be sufficient on the lateral roof frame, and such narrowness may also be desired, on the transverse roof frames a flange extension substantially wider in the longitudinal direction of the vehicle can provide an improved mounting for the panel which can be fastened or bonded thereon.

An advantage of the vehicle roof according to the invention is therefore that the roof side member and the front and rear roof frames provide a surface on the inner side of the vehicle roof or roof frame to which a sealing system can be attached. For this purpose the lower skin in a double-skin roof frame shell, or the middle skin in a three-part roof frame shell, is extended further inwardly toward the roof opening. This configuration results in a level surface on the roof shell which leads to a short overlap of the sheet metal of the front and rear roof frames with the roof side members only in the corner regions. A suitable sealing system, by which a major part of the water entering is drained via the outer skin of the vehicle, can therefore be attached to the roof shell or to the externally-guided sliding roof.

The proportion of water which enters via the mechanism sealing plane is drained into the guide rail and discharged via the water drainage pipe through the interior of the vehicle. The flange on the roof frame may have a straight contour on its free edge and not follow the design contour, simplifying the attachment of the sealing system or the seal, or may have a suitably curved contour, in which case a more complex sealing system is necessary.

Through this procedure the primary plane of the mechanism (inner guide rail) can also be displaced outwardly as far as the roof shell, and the see-through area can be significantly extended in the transverse direction of the roof (Y-direction).

The roof shell makes available the surfaces for attaching a panel of glass, PC, sheet metal, or plastic material in both the front and rear areas. Optionally, the windscreen and rear window may also be extended up to the interface with the externally-guided sliding roof. Through this measure, the front and rear parts of the frame can be uncoupled from the design surface and openings for fixing elements for motors, guide elements and the like can be integrated. At the same time, these elements can be arranged below the front or rear roof frames, widening the see-through area in the X-direction.

With installation from below, the joints on the guide rails are not significant, because, as with a bottom-load system, the water enters directly in the region of the guide rails, which are easy to seal. The joints on the installation flanges play no part with this water management system. The frame can thus be constructed in a modular fashion and therefore at low cost.

The roof shell according to the invention makes available suitable bonding surfaces for attaching a front panel and a rear panel (of glass, PC, sheet metal, LFI, etc.), or for extension of the top of the windscreen or rear window, thereby additionally reinforcing the roof shell, especially if there is a relatively large fixing base in the longitudinal direction (X-direction).

An advantage of this configuration, therefore, is optimized water management even with bottom-load externally-guided sliding roof systems, because a level support surface is made available on the underside of the welding flange of the shell. This water management system is unproblematic because—as is usual with bottom-load systems—joints between frame parts and guide rails can be suitably configured in a simple manner.

Through the functional integration into the roof frame parts fewer components are required, since the frame parts no longer serve as sealing faces and can be moved underneath the shell. Costs are therefore reduced by lower tooling costs for the frame parts and by modularization of the frame components.

The roof module therefore has two rails and at least one connecting element for the rails at the front and/or the rear. Further elements which connect the frame, for example in the middle, may be introduced in order to ensure further functions, such as mounting of a roll-up sun shield, increasing stiffness, etc.

The water management system is configured such that a major part of the water is drained via the vehicle body shell and only a part, which enters the roof via the mechanism seals, is drained via outlets from the guide rails. Adaptation of the vehicle body shell and a corresponding sealing system are decisive for this solution.

The guide rails are fixed to the roof shell (roof frame) directly or by means of suitable adapter elements (rail-to-rail).

The roof module is installed from below (bottom-load). As a result, the front and rear frame parts can be relocated below the front and rear roof frame parts, whereby the see-through area is enlarged in the X-direction and the functional surfaces are uncoupled from the design surfaces. As a result of this uncoupling, openings enabling the functional integration of further elements can be provided in the front and rear frame parts.

The roof module can be made more modular than in the case of a top-load externally-guided sliding roof since the frame of the roof module (guide rails and the like) is composed of a plurality of individual parts which can be reused as appropriate for other vehicle models or applications.

As a result of the situation regarding installation of the externally-guided sliding roof which has been described, of the new water management system and of the arrangement of the guide rails, an all-glass appearance, which corresponds to that of a top-load externally-guided sliding roof, is achieved with a bottom-load externally-guided sliding roof.

A resulting advantage, therefore, is a cost reduction through the modular construction of the frame of the roof module similar to that of a bottom-load sliding-lifting roof, and the possibility of “rail-to-rail” glazing for a larger see-through area in the Y-direction.

### BRIEF DESCRIPTION OF THE DRAWINGS

A vehicle roof according to the invention is explained in more detail below with reference to exemplary embodiments and to the drawing, in which:

FIG. 1 is an isometric top view of a vehicle roof of a passenger car;

FIG. 2 is an isometric top view of a number of components of a structure of the vehicle roof;

FIG. 3 is a cross-sectional view of a side member of the roof structure with components arranged thereon;

FIG. 4 is a cross-sectional view of a further exemplary embodiment of a side member of the roof structure with components arranged thereon;

FIG. 5 is an isometric top view of the left-hand front connection point of the front roof cross member to the left-hand roof side member;

FIG. 6 is an isometric plan view of the underside of the connection point of the front roof cross member to the left-hand roof side member shown in FIG. 6;

FIG. 7 is a longitudinal sectional view of a front cross member of the roof structure with a glass panel fastened thereto, and

FIG. 8 is a longitudinal sectional view of the front roof cross member according to FIG. 4 in a modified embodiment with a drive device of an externally-guided sliding roof system.

### DETAILED DESCRIPTION OF THE INVENTION

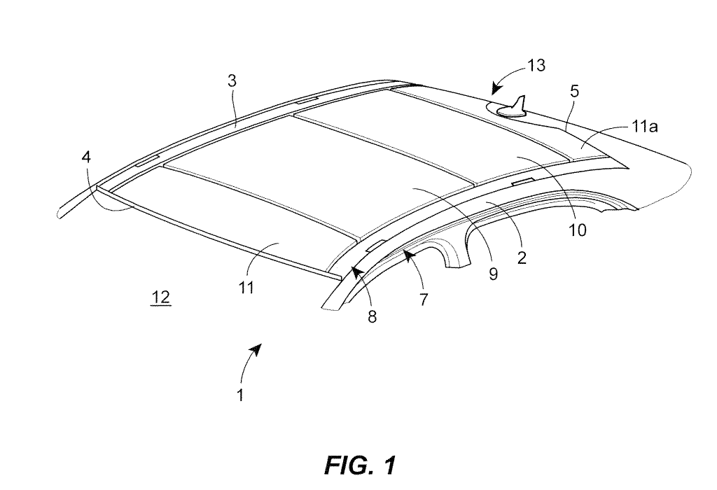

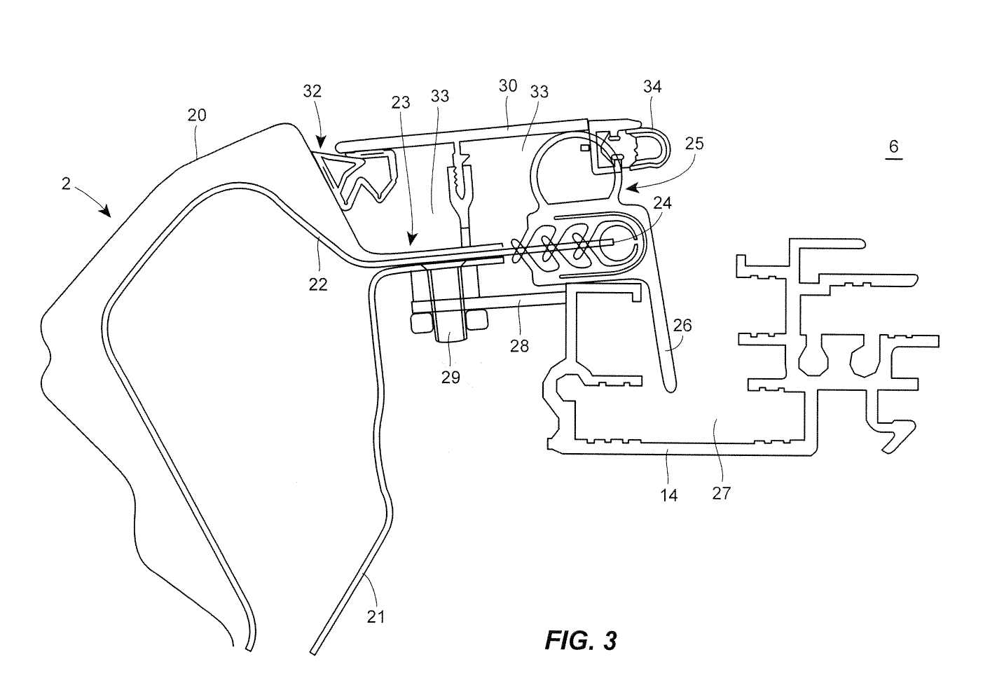

A vehicle has a vehicle roof 1 (FIG. 1) with a roof structure which has a left-hand and a right-hand roof side member 2, 3 and a front roof cross member (windscreen cowl) 4 and a rear roof cross member 5, these members forming a roof frame 7 surrounding on all sides a roof opening 6 (FIG. 3). Attached to the members 2 to 5, or to the roof frame 7, is a roof module 8 which has an externally-guided sliding roof 9 (in principle as known, for example, from DE 197 13 347 A1, the disclosure of which is incorporated herein), and a fixed cover 10 arranged behind the same. The roof module 8 is fastened to the roof frame 7 from below (bottom-load) and a front glass panel 11 and a rear glass panel 11a are fastened to the roof frame 7 from above. Although the sliding roof 9 and the cover 10 are made of glass or are formed in a glass-like manner, the vehicle roof has an all-glass appearance between the windscreen 12 and the rear window 13. Instead of glass, the components may be made of a transparent plastic material. On the other hand, non-transparent embodiments are not ruled out in general.

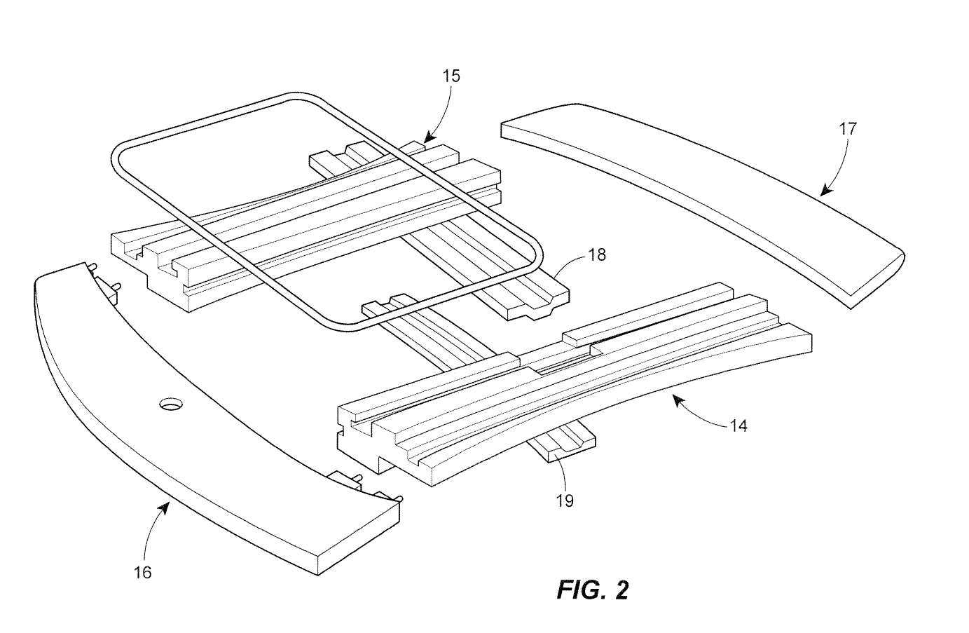

FIG. 2 shows in a schematic representation individual components of a roof module 8 of modular construction. A left-hand and a right-hand guide rail 14, 15 are connected to one another via a front frame part 16 and a rear frame part 17. In addition, a plurality of transverse connecting parts, such as an upper connecting element 18 and the lower connecting element 19, may connect the two guide rails 14, 15 rigidly to one another, impart high strength to the structure and provide mountings for further components such as a roll-up sun shield.

Each roof member 2 to 5 is built up from two interconnected shell-like profile parts or sheet metal profiles, for example an outer profile part 20 and an inner profile part 21, and in this example a roof frame of three-part construction additionally includes a further reinforcing profile part 22, which is arranged between the two profile parts 20 and 21 and forms with them a flange 23 oriented inwardly towards the roof opening 6, on which flange 23 the two profile parts 20 and 21 and the reinforcing profile part 22 are rigidly connected to one another. The reinforcing profile part 22 extends inwards beyond the flange 23 and forms a flange extension 24 on which a seal 25 is fitted. The seal 25 includes a drip lip 26, so that water which has entered is guided into the water channel 27 formed by the guide rail 14 and is drained therefrom to the outside via a discharge means such as a hose.

The guide rail 14 is screwed directly to the underside of the flange 23 by way of a retaining web 28 and by means of studs 29 (only one stud is shown in the drawing plane) arranged at a distance from one another on the flange 23 and, because an intervening carrier frame is neither provided nor required, can be positioned very far outwards against the roof member 2, whereby a see-through area of the roof opening is enlarged in the transverse direction of the vehicle roof.

A covering strip 30 is fastened to the flange 23 by means of a clip connection 31 in such a way that it bears sealingly against the seal 25 on the inner side and is sealed with respect to the roof frame 2 via an edge seal 32 on the outer side. The channel 33 provided between the flange 23 and the covering strip 30 and delimited inwardly by the seal 25 guides water which has entered forwardly to the windscreen 12 or rearwardly to the rear window 13. A seal 34 mounted on the covering strip 30 seals the closed cover 9.

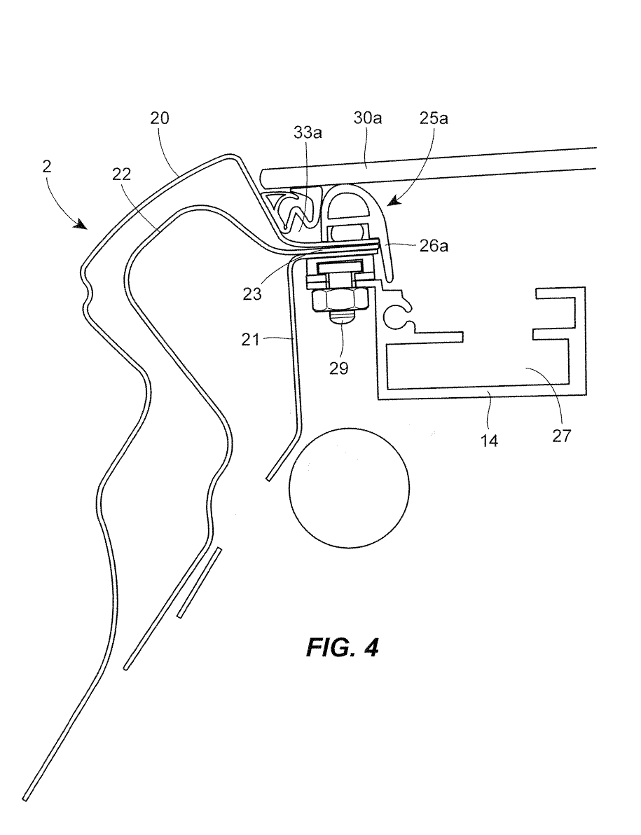

A modification represented in FIG. 4 shows a roof frame 7, or a left-hand roof side member 2, on which the flange 23 is formed by a common width of the two profile parts 20 and 21 and of the reinforcing profile part 22, that is, without a projecting width of the reinforcing profile part 22. The seal 25a is fastened to the upper side of the flange 23. The guide rail 14 is likewise screwed to the underside of the flange 23 by means of the stud 29, and, because of the narrow width of the flange 23 (without a flange extension 24), can be positioned very close to the roof frame 7, or to the roof side member 2.

In this case the channel 33a below the covering strip 30a is narrower, but is dimensioned sufficiently large for water drainage.

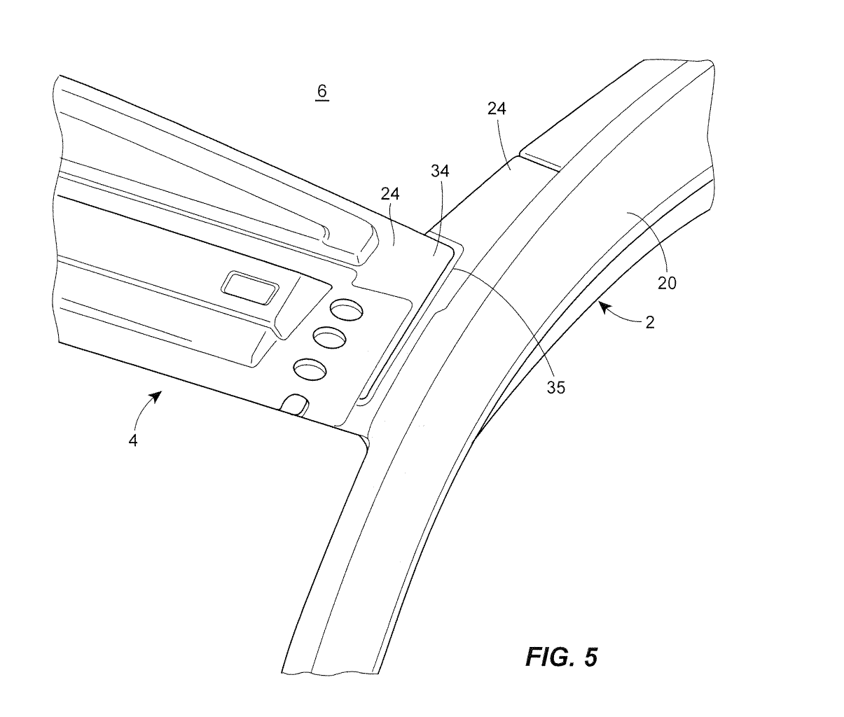

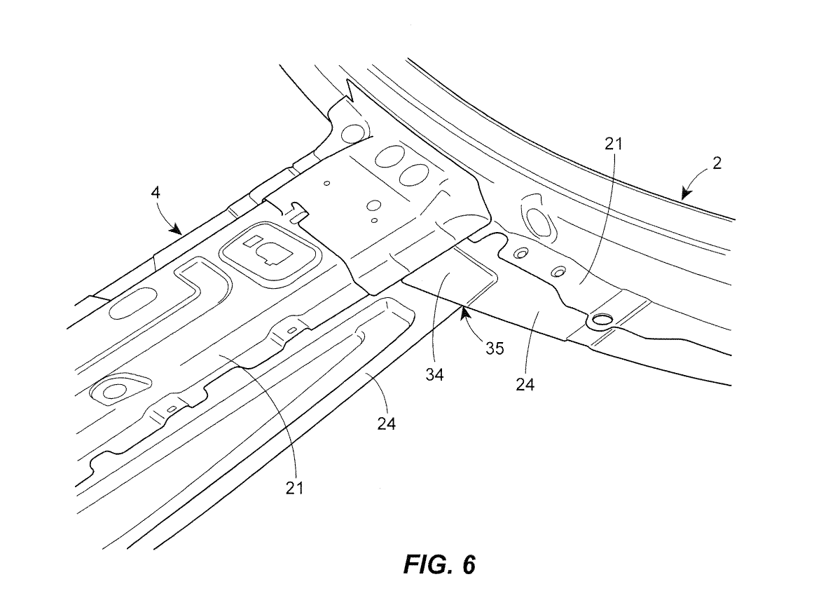

At the transition from the left-hand roof side member 2 to the front roof cross member 4 (windscreen cowl), in the embodiment represented in FIGS. 5 and 6, the two flange extensions 24 are placed one above the other in an overlap region 34 and firmly connected together, a transition as level as possible between the two flange extensions 24 being created by means of a depression 35 impressed in the flange extension 24 of the roof side member 2. The flange extensions 24 are therefore formed continuously all-round and the seal 25, which is preferably formed as a closed profile part running continuously around the roof frame 7, is fitted on to the flange extensions 24 projecting inwardly towards the roof opening 6, so that an uninterrupted seal against the flange extension 24, or the roof frame 7, is achieved.

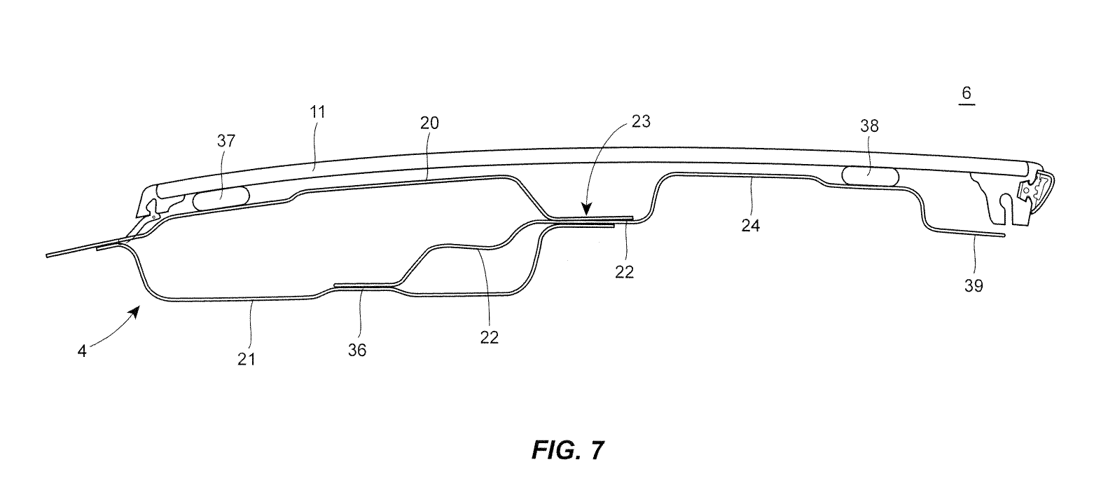

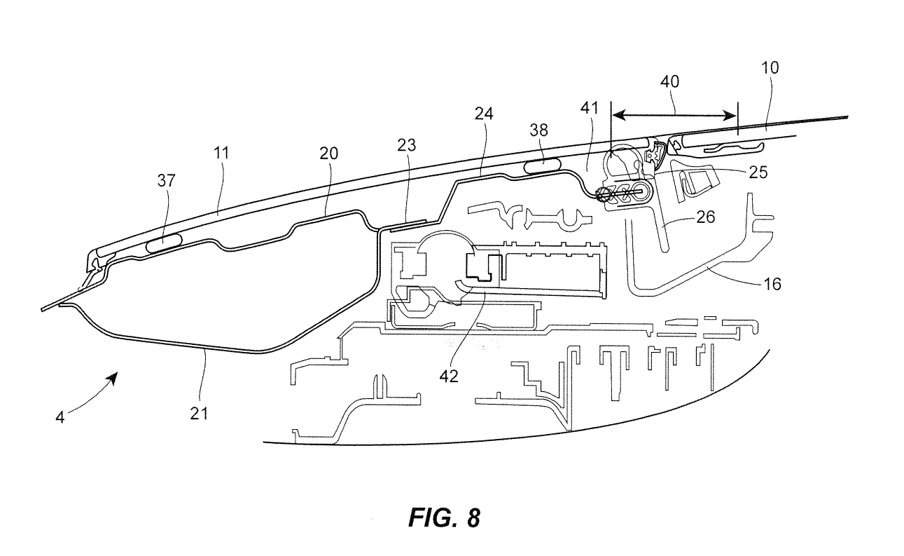

FIGS. 7 and 8 each show a section through the front roof cross member 4 in a vertical longitudinal centre plane of the vehicle roof. The outer profile part 20 and the inner profile part 21 form a closed, stable hollow profile and, together with the reinforcing profile part 22 arranged between them, form the flange 23. The reinforcing profile 22 is firmly connected, e.g. bonded or welded, at its front end to the inner profile part 21 at a connection site 36, and is prolonged on the other side as a profiled flange extension 24 comparatively far in the direction of the roof opening 6 behind the front glass panel 11. At the centre of the front roof cross member 4, the flange extension 24 has approximately the width of the closed profile of the roof cross member 4 (width in the longitudinal direction of the vehicle roof), while the width of the flange extension 24 may decrease towards the ends (as is also apparent from FIG. 5).

The front glass panel 11 is bonded to the outer profile part 20 and the flange extension 24, for example by means of a front adhesive bead 37 and a rear adhesive bead 38. Because the rear adhesive bead 38 is spaced far from the front adhesive bead 37, in particular in the middle section of the roof cross member 4, the glass panel 11 is given a large support base for strong and durable connection or bonding.

The seal 25 is fitted to the end portion 39 of the flange extension 24 adjacent to the roof opening 6. The cover 10 may also be arranged such that its front edge extends beyond the seal 25 (as represented by the arrow 40). Water entering the channel 41 can then drain at the side of the windscreen 12.

The front frame part 16 extends below the drip lip 26 and also guides water away to the side. A drive motor 42 for the (externally-guided) sliding roof 9 is mounted on the front frame part 16 and, with bottom-load installation of the roof module to its installed position, is positioned below the flange 23 or the flange extension 24.

The rear roof cross member 5 may be formed in a comparable way to the front roof cross member 4 illustrated in FIGS. 6 and 7, and may retain the rear glass panel 11a by means of bonded connections, such as adhesive beads, in the manner and arrangement shown in FIGS. 6 and 7.

### LIST OF REFERENCE NUMERALS

1 Vehicle roof
2 Left-hand roof side member
3 Right-hand roof side member
4 Front roof cross member
5 Rear roof cross member
6 Roof opening
7 Roof frame
8 Roof module
9 Sliding roof
10 Cover
11 Front glass panel
11a Rear glass panel
12 Windscreen
13 Rear window
14 Left-hand guide rail
15 Right-hand guide rail
16 Front frame part
17 Rear frame part
18 Upper connecting element
19 Lower connecting element
20 Outer profile part
21 Inner profile part
22 Reinforcing profile part
23 Flange
24 Flange extension
25 Seal
25a Seal
26 Drip lip
27 Water channel
28 Retaining web
29 Stud
30 Covering strip
31 Clip connection
32 Edge seal
33 Channel
33a Channel
34 Overlap area
35 Depression
36 Connection site
37 Front adhesive bead
38 Rear adhesive bead
39 End portion
40 Arrow
41 Channel
42 Drive motor

1. Vehicle roof with a roof frame surrounding a roof opening and a roof module covering the roof opening, the roof module having guide rails and a covering element movably mounted on the guide rails, wherein the roof module has at least two guide rails and a connecting element connecting the guide rails, and wherein at least the guide rails are fastened to the underside of a flange of the roof frame.

2. Vehicle roof according to claim 1, wherein the flange has an inwardly-oriented flange extension which is formed in one layer.

3. Vehicle roof according to claim 1, wherein the flange extension is formed continuously around the roof frame.

4. Vehicle roof according to claim 1, wherein a seal is mounted on the upper side of the flange.

5. Vehicle roof according to claim 2, wherein a continuous seal is fastened to the flange extension.

6. Vehicle roof according to claim 5, wherein the continuous seal is fitted to the edge of the flange extension.

7. Vehicle roof according to claim 4, wherein the seal seals with respect to an upper covering.

8. Vehicle roof according to claim 4, wherein the seal has a drip lip directed into the guide rail.

9. Vehicle roof according to claim 1, wherein the roof module has as a connecting element at least one of a front frame part and a rear frame part.

10. Vehicle roof according to claim 1, wherein the flange extension has, spaced from the flange, an enlarged support base for a panel of the roof outer skin which is attachable thereto.

11. Vehicle roof according to claim 10, wherein the enlarged support base is on at least one of the front roof cross member and the rear roof cross member.

12. Vehicle roof with a roof frame surrounding a roof opening, a roof module covering the roof opening and a flange, formed on the roof frame and oriented toward the roof opening, for fastening the roof module, wherein a flange extension has, spaced from the flange, an enlarged support base for a panel of the roof outer skin which is attachable thereto.

13. Vehicle roof according to claim 1, wherein covering elements of the roof module form, with at least one of a front and a rear glass panel which adjoin at least one of a windscreen and a rear window respectively, a vehicle roof with an all-glass appearance.

14. Vehicle roof according to claim 12, wherein the enlarged support base is on at least one of the front roof cross member and the rear roof cross member.

15. Vehicle roof according to claim 12, wherein the roof module has guide rails and a covering element movably mounted on the guide rails, wherein the roof module has at least two guide rails and a connecting element connecting the guide rails, and wherein at least the guide rails are fastened to the underside of the flange.
